(19) United States
(12) Patent Application Publication
(10) Pub. No.: US 2024/0119382 A1
(43) Pub. Date: Apr. 11, 2024

(54) MIGRATION MANAGEMENT SYSTEM AND METHOD

(71) Applicant: Assembly Software LLC, Coral Gables, FL (US)

(72) Inventor: James W. Garrett, Lakewood Ranch, FL (US)

(21) Appl. No.: 18/478,400

(22) Filed: Sep. 29, 2023

Related U.S. Application Data
(60) Provisional application No. 63/377,665, filed on Sep. 29, 2022.

(51) Int. Cl. G06Q 10/0631; G06F 9/48

(52) U.S. Cl. CPC G06Q 10/06316; G06F 9/4875; G06Q 10/06312

(57) ABSTRACT

A computer-implemented method, computer program product and computing system for: assigning a complexity score to one or more migration portions of a migration pathway for a current migration project, thus defining one or more complexity scores; and effectuating the current migration project via one or more agents.

### RELATED APPLICATION(S)

This application claims the benefit of U.S. Provisional Application No. 63/377,665, filed on 29 Sep. 2022, the entire contents of which are incorporated herein by reference.

### TECHNICAL FIELD

This disclosure relates to migration systems and, more particularly, to migration systems that make predictions concerning the difficulty of a migration.

BACKGROUND

Migrating a computing platform from on-premises to the cloud offers numerous advantages, including scalability and cost-efficiency, but it also comes with a set of significant challenges. One of the primary difficulties is data transfer and bandwidth constraints. Moving large volumes of data to the cloud can be time-consuming and expensive, especially when dealing with limited network bandwidth.

Data security and compliance are critical concerns during migration. Ensuring the protection of sensitive information throughout the process requires robust encryption, access controls, and compliance measures. Additionally, application compatibility poses a challenge, as not all on-premises applications seamlessly transition to the cloud, often necessitating modifications or updates.

Performance and latency issues can arise, particularly for applications heavily reliant on on-premises resources. Organizations must optimize their applications for cloud infrastructure. Cost management is another challenge, as unexpected expenses can occur if cloud usage is not closely monitored and controlled.

Moreover, the shift to the cloud may require staff training or hiring cloud-savvy talent, and organizations can face vendor lock-in, making it difficult to switch providers once committed. Downtime and business continuity concerns are crucial, and integrating cloud-based and on-premises systems can be complex. Cultural resistance to change among employees and teams can further complicate the transition.

Managing cloud resources, establishing governance policies, addressing network complexity, and ensuring backup and disaster recovery are also challenging tasks. Additionally, regulatory and compliance requirements can vary across industries and regions, necessitating adjustments in policies and practices. To mitigate these challenges, organizations must conduct thorough planning, risk assessments, and comprehensive testing while considering the expertise of cloud service providers or third-party consultants to facilitate a successful transition to the cloud.

### SUMMARY OF DISCLOSURE

### Concept 6

In one implementation, a computer-implemented method is executed on a computer device and includes: assigning a complexity score to one or more migration portions of a migration pathway for a current migration project, thus defining one or more complexity scores; and effectuating the current migration project via one or more agents.

One or more of the following features may be included. The one or more agents may include one or more of: a project agent; a file systems agent; and an operational agent. The project agent may be executed on a customer's network associated with the current migration project. The file systems agent may be executed on a customer's network associated with the current migration project. The operational agent may be executed on a service provider's network associated with the current migration project. The current migration project may include an on-premise to cloud IT migration project. Each of the one or more migration portions may concern one or more of: an application migration task; a data migration task; and a general migration task. Each of the one or more complexity scores may define the relatively complexity of each of the one or more migration portions. A project index may be assigned to the current migration project that defines the relative complexity of the current migration project based, at least in part, upon one or more complexity scores. The project index may have a normal value of one and the deviation of the project index above/below the normal value of one may be indicative of the increased/decreased level of complexity of the current migration project with respect to a normal migration project. Staffing levels may be defined for the current migration project based, at least in part, upon the project index. Defining staffing levels for the current migration project based, at least in part, upon the project index may include: defining staffing levels for a plurality of phases of the current migration project based, at least in part, upon the project index.

In another implementation, a computer program product resides on a computer readable medium and has a plurality of instructions stored on it. When executed by a processor, the instructions cause the processor to perform operations including: assigning a complexity score to one or more migration portions of a migration pathway for a current migration project, thus defining one or more complexity scores; and effectuating the current migration project via one or more agents.

One or more of the following features may be included. The one or more agents may include one or more of: a project agent; a file systems agent; and an operational agent. The project agent may be executed on a customer's network associated with the current migration project. The file systems agent may be executed on a customer's network associated with the current migration project. The operational agent may be executed on a service provider's network associated with the current migration project. The current migration project may include an on-premise to cloud IT migration project. Each of the one or more migration portions may concern one or more of: an application migration task; a data migration task; and a general migration task. Each of the one or more complexity scores may define the relatively complexity of each of the one or more migration portions. A project index may be assigned to the current migration project that defines the relative complexity of the current migration project based, at least in part, upon one or more complexity scores. The project index may have a normal value of one and the deviation of the project index above/below the normal value of one may be indicative of the increased/decreased level of complexity of the current migration project with respect to a normal migration project. Staffing levels may be defined for the current migration project based, at least in part, upon the project index. Defining staffing levels for the current migration project based, at least in part, upon the project index may include: defining staffing levels for a plurality of phases of the current migration project based, at least in part, upon the project index.

In another implementation, a computing system includes a processor and a memory system configured to perform operations including: assigning a complexity score to one or more migration portions of a migration pathway for a current migration project, thus defining one or more complexity scores; and effectuating the current migration project via one or more agents.

One or more of the following features may be included. The one or more agents may include one or more of: a project agent; a file systems agent; and an operational agent. The project agent may be executed on a customer's network associated with the current migration project. The file systems agent may be executed on a customer's network associated with the current migration project. The operational agent may be executed on a service provider's network associated with the current migration project. The current migration project may include an on-premise to cloud IT migration project. Each of the one or more migration portions may concern one or more of: an application migration task; a data migration task; and a general migration task. Each of the one or more complexity scores may define the relatively complexity of each of the one or more migration portions. A project index may be assigned to the current migration project that defines the relative complexity of the current migration project based, at least in part, upon one or more complexity scores. The project index may have a normal value of one and the deviation of the project index above/below the normal value of one may be indicative of the increased/decreased level of complexity of the current migration project with respect to a normal migration project. Staffing levels may be defined for the current migration project based, at least in part, upon the project index. Defining staffing levels for the current migration project based, at least in part, upon the project index may include: defining staffing levels for a plurality of phases of the current migration project based, at least in part, upon the project index.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a migration management process according to an embodiment of the present disclosure;

FIG. 2 is a diagrammatic view of a migration project effectuated by the migration management process of FIG. 1 according to an embodiment of the present disclosure;

FIG. 3 is a flowchart of the migration management process of FIG. 1 according to an embodiment of the present disclosure;

FIG. 4 is a diagrammatic view of a staffing chart generated by the migration management process of FIG. 1 according to an embodiment of the present disclosure; and

FIG. 5 is another flowchart of the migration management process of FIG. 1 according to an embodiment of the present disclosure.

Like reference symbols in the various drawings indicate like elements.

### DETAILED DESCRIPTION OF THE PREFERRED EMBODIMENTS

### System Overview

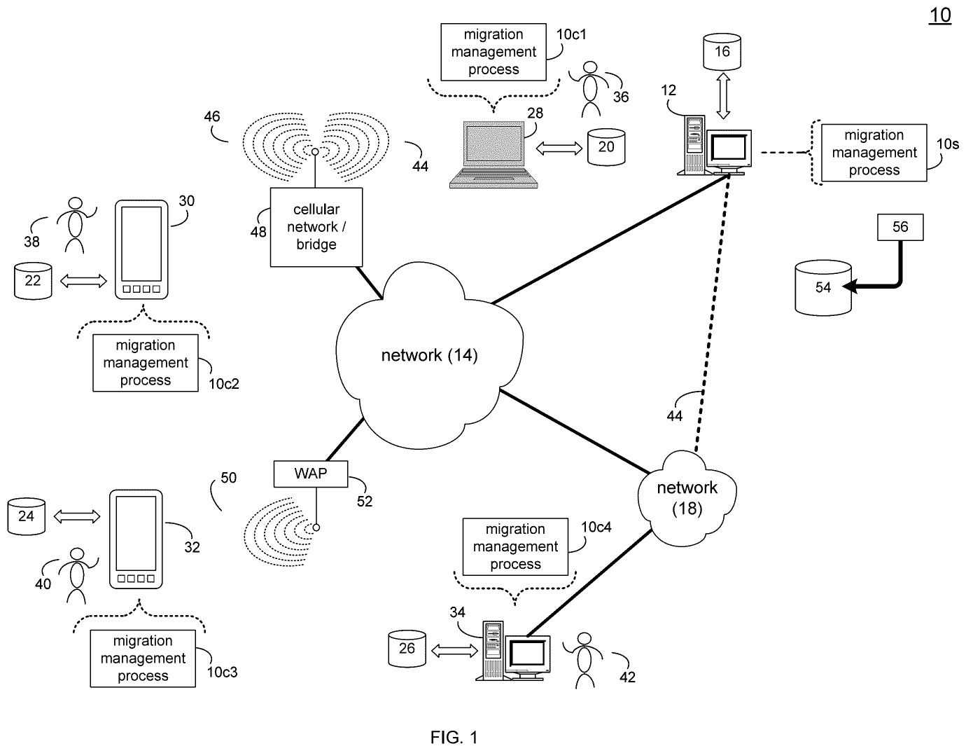

Referring to FIG. 1, there is shown migration management process 10. Migration management process 10 may be implemented as a server-side process, a client-side process, or a hybrid server-side/client-side process. For example, migration management process 10 may be implemented as a purely server-side process via migration management process 10s. Alternatively, migration management process 10 may be implemented as a purely client-side process via one or more of migration management process 10c1, migration management process 10c2, migration management process 10c3, and migration management process 10c4. Alternatively still, migration management process 10 may be implemented as a hybrid server-side/client-side process via migration management process 10s in combination with one or more of migration management process 10c1, migration management process 10c2, migration management process 10c3, and migration management process 10c4. Accordingly, migration management process 10 as used in this disclosure may include any combination of migration management process 10s, migration management process 10c1, migration management process 10c2, migration management process 10c3, and migration management process 10c4.

Migration management process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of migration management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of migration management processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of migration management processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to a personal digital assistant (not shown), a tablet computer (not shown), laptop computer 28, smart phone 30, smart phone 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access migration management process 10 directly through network 14 or through secondary network 18. Further, migration management process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and smart phone 30 are shown wirelessly coupled to network 14 via wireless communication channels 44, 46 (respectively) established between laptop computer 28, smart phone 30 (respectively) and cellular network/bridge 48, which is shown directly coupled to network 14. Further, smart phone 32 is shown wirelessly coupled to network 14 via wireless communication channel 50 established between smart phone 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between smart phone 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

### Migration Management Process

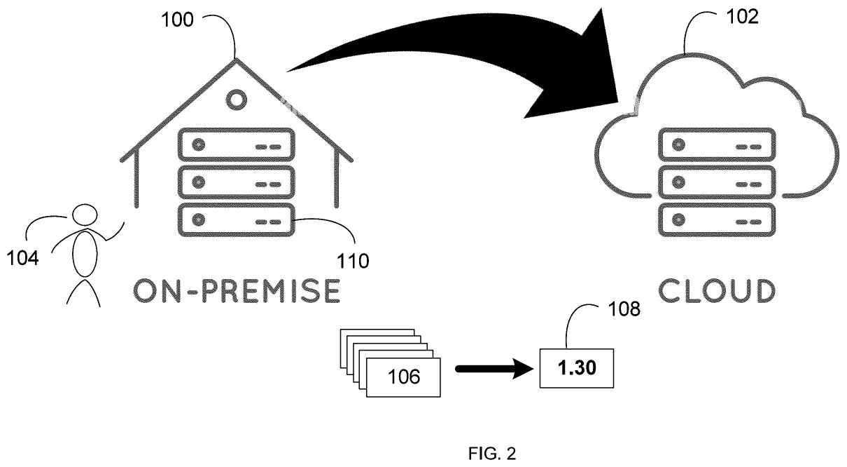

Referring also to FIG. 2 and as will be discussed below in greater detail, migration management process 10 may enable a smooth transition from an on-premise computing platform (e.g., on-premise computing platform 100) to a cloud-based computing platform (e.g., cloud-based computing platform 102). Specifically, migration management process 10 may analyze the on-premise computing platform (e.g., on-premise computing platform 100) of the customer (e.g., customer 104) and make predictions concerning the complexity level of the migration to the cloud-based computing platform (e.g., cloud-based computing platform 102) as well as the level of staffing required to effectuate the migration.

As is known in the art, an on-premises computing platform (e.g., on-premise computing platform 100), often known as “on-prem,” represents the traditional model of computing where organizations maintain and manage all their hardware, software, and networking resources within their own physical data centers or facilities. In this setup, the computing infrastructure is located on-site or at a dedicated organizational location. It grants complete ownership and control over every aspect of the infrastructure to the organization, including the purchase, maintenance, and upgrades of servers, storage, and networking equipment. However, it involves significant capital expenditures, as organizations must invest upfront in hardware and bear the ongoing operational costs. Scalability is limited, and scaling up or down can be time-consuming and costly. Routine maintenance, security, and compliance are entirely the organization's responsibility, with physical security measures also falling under its jurisdiction.

In contrast, a cloud-based computing platform (e.g., cloud-based computing platform 102) operates on infrastructure provided by cloud service providers like AWS, Azure, or Google Cloud, located in data centers distributed globally. Users access these resources and services over the internet, and while they have control over configuring and managing the resources they use, they do not own or manage the underlying infrastructure. Cloud computing operates on an operational expense model, where users pay only for the resources they consume, converting capital expenditures into operational ones. Scalability is a key advantage, with the ability to quickly and efficiently scale resources up or down based on demand. Cloud providers handle routine maintenance, hardware upgrades, and software updates, reducing operational burden and ensuring services remain up-to-date and secure. These providers also invest significantly in security measures and hold various compliance certifications, with users responsible for configuring security settings within their own cloud environments. The global reach of cloud platforms allows for resource deployment in multiple regions worldwide, improving availability and reducing latency for end-users. Ultimately, the choice between on-premises and cloud-based computing platforms depends on an organization's specific needs, budget, and strategic goals.

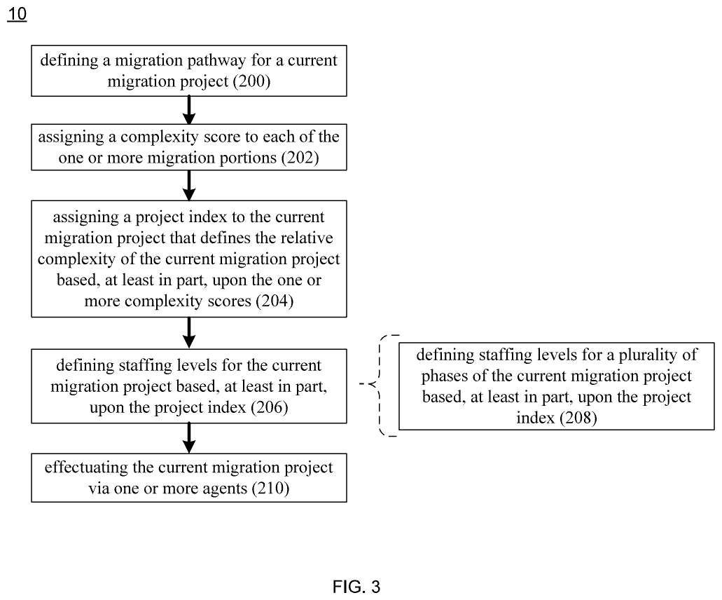

Referring also to FIG. 3, migration management process 10 may define 200 a migration pathway for a current migration project (e.g., an on-premise to cloud IT migration project from on-premise computing platform 100 to cloud-based computing platform 102).

Below is an example of such a migration pathway:

Local Source=(App1+App2+App3+Data1+Encrypt)→Cloud Target

Generally speaking, a migration pathway (such as the one above) may generally define a migration project. In all but the simplest of migrations, a migration pathway (such as the one above) may include one or more migration portions. For the above-shown migration pathway, the migration pathway is shown to include five migration portions, as follows:

Local Source=(App1)→Cloud Target

Local Source=(App2)→Cloud Target

Local Source=(App3)→Cloud Target

Local Source=(Data1)→Cloud Target

Local Source=(Encrypt)→Cloud Target

Each of the one or more migration portions (e.g., the five migration portions shown above) may concern one or more of: an application migration task; a data migration task; and a general migration task.

### Application Migration Tasks

With respect to the five migration portions, the following may be Application Migration Tasks:

Local Source=(App1)→Cloud Target

Local Source=(App2)→Cloud Target

Local Source=(App3)→Cloud Target

An application migration task, in the context of cloud migration, refers to the process of moving an existing on-premises or legacy application to a cloud-based environment. This task is a crucial component of a broader cloud migration strategy and involves several steps and considerations.

Examples of application migration tasks may include but are not limited to:
Assessment and Planning: Before migrating an application to the cloud, it's essential to assess its current state, dependencies, and requirements. This assessment helps in creating a migration plan that outlines the specific steps and goals for the migration.
Selection of Cloud Platform: Choose the appropriate cloud service provider (e.g., AWS, Azure, Google Cloud) and the specific services within that provider's portfolio that best match the needs of the application. Consider factors like compute resources, storage options, and managed services.
Data Migration: Determine how the application's data will be migrated to the cloud. This may involve transferring databases, files, and other data to cloud-based storage solutions. Data migration strategies should consider data consistency, integrity, and minimal downtime.
Application Compatibility: Assess whether the application is compatible with the target cloud environment. Some applications may require modifications or updates to function correctly in the cloud, considering differences in underlying infrastructure, network configurations, and security policies.
Resource Provisioning: Set up the necessary cloud resources, including virtual machines (VMs), containers, storage, and networking components, to host the application. Ensure that these resources align with the application's requirements and scalability needs.
Configuration and Optimization: Configure the cloud environment to match the application's requirements. This includes network configurations, security settings, and performance optimizations to ensure optimal functionality.
Testing: Thoroughly test the migrated application in the cloud environment to identify and address any issues related to performance, compatibility, or functionality. This often involves conducting various types of testing, such as load testing, integration testing, and user acceptance testing.
Data Synchronization: If the application relies on data stored on-premises or in another location, establish mechanisms for real-time or periodic data synchronization between the cloud and on-premises environments to ensure data consistency.
Security and Compliance: Implement security measures and compliance standards specific to the cloud environment, ensuring that the application and its data remain secure and compliant with relevant regulations.
Monitoring and Optimization: Set up monitoring and alerting systems to continuously monitor the application's performance and health in the cloud. Implement cost optimization strategies to manage cloud expenses effectively.
Deployment and Cutover: Once testing is successful and the cloud environment is fully configured, schedule a cutover or migration window to transition the application from the on-premises environment to the cloud. This step should minimize downtime and potential disruptions.
Post-Migration Validation: After the migration is complete, perform post-migration validation to ensure that the application is functioning as expected in the cloud environment. Monitor for any issues that may arise during the initial period after migration.
Documentation and Knowledge Transfer: Document the cloud configuration, procedures, and any changes made during migration. Provide training and knowledge transfer to the operations and support teams to ensure they can effectively manage and maintain the application in the cloud.

### Data Migration Tasks

With respect to the five migration portions, the following may be Data Migration Tasks:

Local Source=(Data1)+Cloud Target

A data migration task, in the context of cloud migration, refers to the process of moving data from an organization's on-premises or legacy systems to a cloud-based environment. Data migration is a fundamental component of most cloud migration projects because it involves transferring critical data assets, such as databases, files, and application data, to the cloud.

Examples of data migration tasks may include but are not limited to:
Assessment and Planning: Begin by assessing the existing data landscape, including the types of data, their volume, and their dependencies. Understand the data's structure, format, and relationships with applications and other data sources. Create a data migration plan that outlines the scope, goals, and timeline for the migration.
Data Classification: Categorize the data based on its sensitivity, importance, and access requirements. This classification helps determine security and compliance measures during migration.
Data Mapping and Transformation: Identify the source and target data systems and create a mapping between them. Define any necessary data transformations or conversions to ensure that data in the cloud format matches the requirements of the target applications.
Data Cleansing and Quality Assurance: Perform data cleansing and quality checks to ensure that the data is accurate, consistent, and free of errors or duplicates. This step is critical to maintain data integrity during migration.
Data Extraction: Extract data from the source systems using appropriate methods and tools. This may involve database exports, file transfers, or other data extraction techniques.
Data Transfer: Transmit the extracted data to the cloud-based storage or databases using secure and efficient data transfer methods. Cloud providers often offer data transfer services and tools to facilitate this step.
Data Loading: Load the data into the target cloud environment, which may involve populating cloud-based databases, file storage systems, or data warehouses. Ensure that the data maintains its integrity during this process.
Data Validation and Testing: Perform data validation and testing to ensure that the migrated data is accurate and complete. Verify that data relationships are maintained, and conduct testing to confirm that applications can access and use the data correctly.
Data Synchronization: Establish mechanisms for real-time or periodic data synchronization between the on-premises systems and the cloud-based systems, especially if both environments will coexist during the migration period.
Security and Compliance: Implement security measures, encryption, and access controls to protect data during transit and storage in the cloud. Ensure compliance with relevant data protection regulations.
Monitoring and Logging: Set up monitoring and logging for the data migration process to track progress, identify issues, and address any errors or failures promptly.
Data Rollback Plan: Develop a data rollback plan in case any issues or unexpected problems arise during migration. This plan should outline steps to revert to the previous state if necessary.
Documentation: Document the entire data migration process, including details of the migration strategy, data mapping, transformation rules, and testing results. This documentation is valuable for audit purposes and future reference.

### General Migration Tasks

With respect to the five migration portions, the following may be General Migration Tasks:

Local Source32 (Encrypt)→Cloud Target

In a cloud migration project, in addition to application and data migration tasks, there are several general tasks that are essential for the successful transition from on-premises or legacy systems to the cloud. These general tasks encompass various aspects of the migration process and play a crucial role in ensuring a smooth and efficient migration.

Examples of common general tasks may include but are not limited to:
Assessment and Strategy Development: Assess the current IT infrastructure, business needs, and objectives to create a comprehensive cloud migration strategy. This task involves understanding the organization's goals and determining which applications and services are suitable for migration to the cloud.
Cloud Provider Selection: Choose a cloud service provider (e.g., AWS, Azure, Google Cloud) based on factors like cost, features, compliance, and compatibility with the organization's needs. Evaluate and compare different cloud providers to make an informed decision.
Budgeting and Cost Analysis: Develop a budget for the migration project, taking into account the costs associated with cloud services, data transfer, training, and any necessary infrastructure upgrades. Create cost estimates and forecasts for ongoing cloud operations.
Security and Compliance Planning: Plan for security measures and compliance requirements specific to the cloud environment. Implement security policies, access controls, encryption, and compliance standards to protect data and ensure regulatory compliance.
Network Architecture Design: Design the network architecture for the cloud environment, including connectivity, subnets, VPNs, and routing configurations. Ensure that the network infrastructure supports the migration and meets performance and security requirements.
Identity and Access Management (IAM): Set up IAM policies and controls to manage user access and permissions within the cloud environment. Define roles, access levels, and authentication mechanisms to ensure secure access.
Backup and Disaster Recovery Planning: Establish backup and disaster recovery strategies for data and applications in the cloud. Implement regular backup schedules and recovery procedures to minimize downtime and data loss.
Training and Skill Development: Provide training and skill development opportunities for IT staff to ensure they are proficient in managing cloud resources and technologies. Familiarize team members with the chosen cloud platform's tools and services.
Change Management and Communication: Develop a change management plan to communicate the migration process and its impact on employees, customers, and stakeholders. Manage expectations and address concerns throughout the migration.
Testing and Validation: Conduct thorough testing and validation of the entire cloud environment, including applications, infrastructure, and data, to ensure that everything functions as expected. Address any issues or performance bottlenecks that arise during testing.
Performance Optimization: Optimize the cloud environment for performance and cost-efficiency. Adjust resource configurations, auto-scaling settings, and load balancing to meet application performance requirements while minimizing costs.
Monitoring and Management Tools: Implement monitoring and management tools to continuously monitor the health, performance, and security of cloud resources. Set up alerts and dashboards for proactive issue detection and resolution.
Documentation and Knowledge Transfer: Document the entire migration process, including architectural diagrams, configurations, and procedures. Share this documentation with the IT team for reference and future management.
Post-Migration Review and Optimization: After the migration is complete, conduct a post-migration review to assess the success of the migration and identify areas for further optimization. Continuously monitor and optimize cloud resources for ongoing efficiency.

Migration management process 10 may assign 202 a complexity score to each of the one or more migration portions, thus defining one or more complexity scores (e.g., complexity scores 106). Continuing with the above-stated example, the migration pathway is as follows:

Local Source=(App1+App2+App3+Data1+Encrypt1)→Cloud Target

As also discussed above, this migration pathway may generally define a migration project. For the above-shown migration pathway, the migration pathway includes five migration portions, as follows:

Local Source=(App1)→Cloud Target

Local Source=(App2)→Cloud Target

Local Source=(App3)→Cloud Target

Local Source=(Data1)→Cloud Target

Local Source=(Encrypt1)→Cloud Target

Accordingly, migration management process 10 may assign 202 a complexity score to each of these five migration portions, thus defining five complexity scores (e.g., complexity scores 106), wherein each of these complexity scores (e.g., complexity scores 106) may define the relatively complexity of each of these migration portions.

General speaking and as will be discussed below in greater detail, historical information concerning such complexities assigned 202 to these five migration portions may be stored within a complexity prediction model (e.g., complexity prediction model 54). For example, complexity prediction model 54 may define the historical complexities associated with various application migration tasks; various data migration tasks; and various general migration tasks. Accordingly, complexity prediction model 54 may define a complexity score (e.g., one of complexity scores 106) for various applications that may be migrated to the cloud, various types of data that may be migrated to the cloud, and various general tasks that may be performed during a migration to the cloud.

For example and with respect to the “App 1” migration portion, the complexity score (e.g., one of complexity scores 106) for this migration portion may be calculated as follows:

### App1 Complexity Score

(NumberOfActiveDcumentTemplates*.5)+
LargeCaseLoad as (case when ClosedCases<=30000 then 0 else((ClosedCases−15000)/15000) end)+
(AvgUniqueTaskTypesPerCaseType*.25)+
RegisteredIntegrations+
CurrentCaseLoad as (case when ActiveCases<=100 then 0 else(ActiveCases/5000) end)+
NumberOfUsers as (case when StaffCount<=50 then 0 else ((StaffCount/50) *.5) end)+
CustomCaseForms as (case when TabsPerCaseTypeAvg<=24 then 0 else((TabsPerCaseTypeAvg−17)*.25) end)+
TotalUserDefinedTypes as (UDFPublishedForms*1.25)+
AvgUDFTypesPerCaseType as (UDFFieldsPerPublishedFormAvg*1.25)+
(CustomReports*.5)+
(DashboardQueries*.25)+
(PDFTemplates*.025)+
(CaseTypes*.5)+
DefenseCaseTypes+
(WordTemplates*.005)+
(ExcelTemplates*.5)+
TemplatePackages+
OfficeLocations+
CasesWithBothCaseSpecificAndCaseTypeSpecificTabConfiguration+
(FirmSpecificCustomizations*1.5)+
(ArchiveDB*10)+
(EncryptionOn*10)

The above-illustrated complexity calculation template for “App1” (which may be stored within complexity prediction model 54) is for illustrative purposes only and is not intended to be a limitation of this disclosure. Accordingly, the above-illustrated complexity calculation template is simply provided to show one manner in which a complexity score (e.g., one of complexity scores 106) may be calculated for a migration portion that concerns “App1”. Assume for this example that a similar complexity calculation template (for “App2”, “App3”, “Data1” and “Encrypt1”) may be stored within (and available from) complexity prediction model 54, wherein such similar complexity calculation templates (for “App2”, “App3”, “Data1” and “Encrypt1”) may be utilized by migration management process 10 to assign 202 a complexity score (e.g., one of complexity scores 106) to the migration portions that concern “App2”, “App3”, “Data1” and “Encrypt1”.

Migration management process 10 may assign 204 a project index (e.g., project index 108) to the current migration project (e.g., an on-premise to cloud IT migration project from on-premise computing platform 100 to cloud-based computing platform 102) that defines the relative complexity of the current migration project (e.g., an on-premise to cloud IT migration project from on-premise computing platform 100 to cloud-based computing platform 102) based, at least in part, upon the one or more complexity scores (e.g., complexity scores 106).

As discussed above, this migration pathway may generally define a migration project, wherein the migration pathway (in this example) includes five migration portions, as follows:

Local Source=(App1)→Cloud Target

Local Source=(App2)→Cloud Target

Local Source=(App3)→Cloud Target

Local Source=(Data1)→Cloud Target

Local Source=(Encrypt1)→Cloud Target

As discussed above, the above-illustrated complexity calculation templates stored within (and available from) complexity prediction model 54 may be utilized by migration management process 10 to assign 202 a complexity score (e.g., one of complexity scores 106) to each of the migration portions that concern “App1”, “App2”, “App3”, “Data1” and “Encrypt1”.

Accordingly, migration management process 10 may assign 204 a project index (e.g., project index 108) to the current migration project (e.g., an on-premise to cloud IT migration project from on-premise computing platform 100 to cloud-based computing platform 102) that defines the relative complexity of the current migration project based, at least in part, upon these complexity scores (e.g., complexity scores 106), which correspond to the five migration portions that concern “App1”, “App2”, “App3”, “Data1” and “Encrypt1”).

An example of the manner in which the project index (e.g., project index 108) may be calculated by the migration management process 10 is as follows:

((ComplexityScore*.01)+(User Count*.01))*sum(Journey Contribution)

The above-illustrated project index calculation template is for illustrative purposes only and is not intended to be a limitation of this disclosure. Accordingly, the above-illustrated project index template is simply provided to show one manner in which a project index (e.g., project index 108) may be calculated for a migration project (e.g., an on-premise to cloud IT migration project from on-premise computing platform 100 to cloud-based computing platform 102) that includes migration portions for “App1”, “App2”, “App3”, “Data1” and “Encrypt1”.

The “ComplexityScore” referenced above may represent the complexity scores (e.g., complexity scores 106) of the five migration portions associated with “App1”, “App2”, “App3”, “Data1” and “Encrypt1”. For example, the “ComplexityScore” referenced above may be e.g., an unweighted average of the five complexity scores (e.g., complexity scores 106), a weighted average of the five complexity scores (e.g., complexity scores 106), a sum of the five complexity scores (e.g., complexity scores 106), etc.

The “sum(Journey Contribution)” referenced above may represent the sum of weights of the various components that make up the current migration project (e.g., an on-premise to cloud IT migration project from on-premise computing platform 100 to cloud-based computing platform 102).

Examples of such weights and how they pertain to tasks within a migration is as follows:

| | JourneyContri- | | JourneyContri- |
|---|---|---|---|
| SourceSystem | bution | SourceSystem | bution |
| Abacus | 1.25 | Needles 5 Sybase | 0.45 |
| Aderant | 1.35 | Net New | 0.25 |
| Amicus | 1.25 | Ontos | 1.50 |
| CasePeer | 1.35 | Practice Master | 1.35 |
| Clio | 1.25 | Practice Panther | 1.35 |
| CloudLex | 1.35 | Prevail | 1.35 |
| Crocodile | 1.35 | ProLaw | 1.35 |
| Coyote | 0.50 | SAGA | 1.25 |
| File System | 0.15 | Smart Advocate | 1.50 |
| Filevine | 1.50 | SmokeBall | 1.25 |
| iManage | 1.25 | Tabs3 | 1.50 |
| Legal Assistant | 1.50 | Time Matters | 1.35 |
| Legal Files | 1.50 | Tort Pro | 1.50 |
| Litify | 1.50 | TrialWorks | 0.95 |
| MyCase | 1.25 | TriTech | 1.50 |
| Needles 4 | 0.50 | Quickbooks | 0.15 |
| Needles 5 SQL | 0.45 | | |

So if the current migration project (e.g., an on-premise to cloud IT migration project from on-premise computing platform 100 to cloud-based computing platform 102) concerns the migration of an Abacus™ installation, a Quickbooks™ installation and an Ontos installation, the “sum(Journey Contribution)” would be 2.90 (1.25 for Abacus™+0.15 Quickbooks™+1.50 Ontos™ respectively).

The project index (e.g., project index 108) may have a normal value of one and the deviation of the project index (e.g., project index 108) above/below the normal value of one may be indicative of the increased/decreased level of complexity of the current migration project (e.g., an on-premise to cloud IT migration project from on-premise computing platform 100 to cloud-based computing platform 102) with respect to a normal migration project.

Accordingly:
if the current migration project (e.g., an on-premise to cloud IT migration project from on-premise computing platform 100 to cloud-based computing platform 102) has a project index (e.g., project index 108) of 1.00, the current migration project will likely be as difficult as a normal migration project;
if the current migration project (e.g., an on-premise to cloud IT migration project from on-premise computing platform 100 to cloud-based computing platform 102) has a project index (e.g., project index 108) of 1.50, the current migration project will likely be 50% more difficult than a normal migration project; and
if the current migration project (e.g., an on-premise to cloud IT migration project from on-premise computing platform 100 to cloud-based computing platform 102) has a project index (e.g., project index 108) of 0.70, the current migration project will likely be 30% less difficult than a normal migration project.

Migration management process 10 may define 206 staffing levels for the current migration project (e.g., an on-premise to cloud IT migration project from on-premise computing platform 100 to cloud-based computing platform 102) based, at least in part, upon the project index (e.g., project index 108). For example and when defining 206 staffing levels for the current migration project (e.g., an on-premise to cloud IT migration project from on-premise computing platform 100 to cloud-based computing platform 102) based, at least in part, upon the project index (e.g., project index 108), migration management process 10 may define 208 staffing levels for a plurality of phases of the current migration project (e.g., an on-premise to cloud IT migration project from on-premise computing platform 100 to cloud-based computing platform 102) based, at least in part, upon the project index (e.g., project index 108).

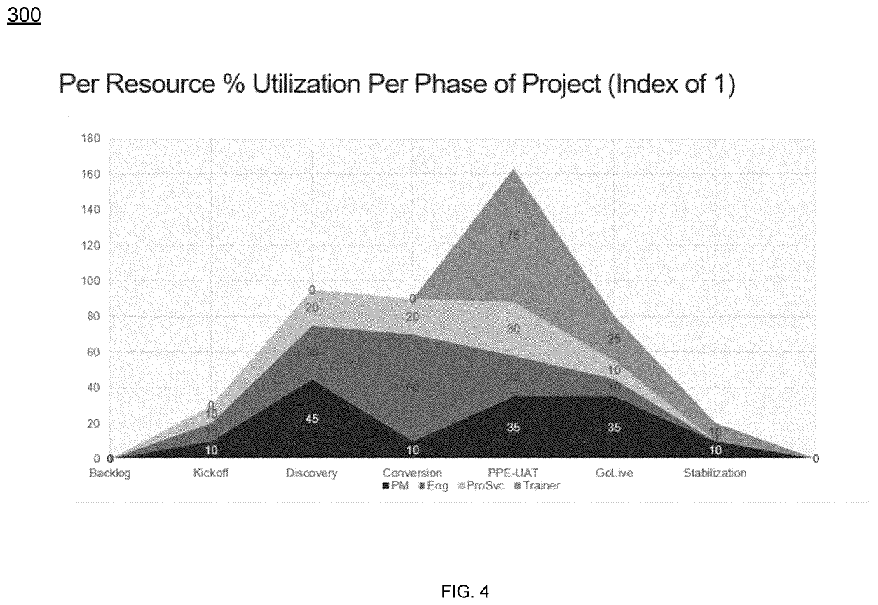

For example and referring also to FIG. 4, there is shown a staffing chart (e.g., staffing chart 300) for the current migration project (e.g., an on-premise to cloud IT migration project from on-premise computing platform 100 to cloud-based computing platform 102) based, at least in part, upon the project index (e.g., project index 108).

While this particular staffing chart (e.g., staffing chart 300) is shown to define four types of professionals (e.g., Project Manager, Engineer, Professional Services Provider, Trainer), this is for illustrative purposes only and is not intended to be a limitation of this disclosure. For example, the number of professional types defined may be increased/decreased depending upon the desired level of staffing granularity (when defining 206 staffing levels for the current migration project based, at least in part, upon project index 108).

Additionally, this particular staffing chart (e.g., staffing chart 300) is shown to define seven phases (e.g., backlog, kickoff, discovery, conversion, PPE-UAT, GoLive, Stabilization), this is for illustrative purposes only and is not intended to be a limitation of this disclosure. For example, the number of phases may be increased or decreased depending upon the desired level of staffing granularity (when defining 208 staffing levels for a plurality of phases of the current migration project based, at least in part, upon project index 108).

Further, while this particular staffing chart (e.g., staffing chart 300) is shown for a project index (e.g., project index 108) of 1.00, this is for illustrative purposes only and is not intended to be a limitation of this disclosure. For example, this particular staffing chart (e.g., staffing chart 300) may be scaled upward if project index 108 is higher (e.g., for a project index of 1.50), while this particular staffing chart (e.g., staffing chart 300) may be scaled downward if project index 108 is lower (e.g., for a project index of 0.70).

Specifically, staffing chart 300 indicates that the current migration project (e.g., an on-premise to cloud IT migration project from on-premise computing platform 100 to cloud-based computing platform 102) requires 0.35 Project Managers/0.23 Engineers/0.30 Professional Service Providers/0.75 Trainers for the PPE-UAT phase of the current migration project having a project index (e.g., project index 108) of 1.00.

However, if the current migration project (e.g., an on-premise to cloud IT migration project from on-premise computing platform 100 to cloud-based computing platform 102) has a project index (e.g., project index 108) of 1.50, the staffing requirements for the current mitigation project may be scaled up accordingly (e.g., to 0.52 Project Managers/0.34 Engineers/0.45 Professional Service Providers/1.12 Trainers during the PPE-UAT phase.

Conversely, if the current migration project (e.g., an on-premise to cloud IT migration project from on-premise computing platform 100 to cloud-based computing platform 102) has a project index (e.g., project index 108) of 0.70, the staffing requirements for the current mitigation project may be scaled down accordingly (e.g., to 0.24 Project Managers/0.16 Engineers/0.21 Professional Service Providers/0.52 Trainers during the PPE-UAT phase.

Migration management process 10 may effectuate 210 the current migration project (e.g., an on-premise to cloud IT migration project from on-premise computing platform 100 to cloud-based computing platform 102) via one or more agents (e.g., one or more of: a project agent; a file systems agent; and an operational agent).
The project agent may be executed on a customer's network (e.g., network 110 owned by customer 104) associated with the current migration project (e.g., an on-premise to cloud IT migration project from on-premise computing platform 100 to cloud-based computing platform 102).
The file systems agent may be executed on a customer's network (e.g., network 110 owned by customer 104) associated with the current migration project (e.g., an on-premise to cloud IT migration project from on-premise computing platform 100 to cloud-based computing platform 102).
The operational agent may be executed on a service provider's network (e.g., network 14/network 18) associated with the current migration project (e.g., an on-premise to cloud IT migration project from on-premise computing platform 100 to cloud-based computing platform 102).

The project agent may perform various operations, examples of which may include but are not limited to:
Database backup and upload
Execution of tests from pathways and phases
Sync of local appointments to M365
Download of outstanding tasks and tests
Upload of forensic reporting against environment
Correction of non-type-controlled data
Request user input or override and acceptance of outlier configurations
Local data maintenance (indexing, shrinking)
Capture and upload usage statistics

The file systems agent may perform various operations, examples of which may include but are not limited to:
Document discovery and case linkage (interacting with local software database for context searching)
MSOffice document version upgrading and compatibility checks (e.g. doc to docx, Office 2015 to Office 2022)
Document Macro and active content validation and mitigation
Non-office document to office document conversion (e.g. WordPerfect, google to MSWord)
Inventory overview upload with document checksum for migration validation
Upload from file system to target storage, in organized fashion (into target structure for folders, subfolders, etc)
Metadata uploaded for manifestation in target system (e.g. last modified date, author, etc)
Monitoring for any change to discovered and uploaded document for real-time delta

The operational agent may perform various operations, examples of which may include but are not limited to:
Convert uploaded database backup to target system
Create target production environment and deploy data into it
Create user records for discovered users in local system
Apply configurations from catalogs to deployed customer environments
Execute pre and post deployment scripts against specific customer environment
Send “nag” messages to project owners, affected users, and customer executives when project is waiting on humans
Adjust hardware deployment levels based on learned usage levels to ensure target is performant

Each pathway may have specific tests and events that migration management process 10 may perform as part of completing a phase (e.g., one of the above-referenced seven phases, namely backlog, kickoff, discovery, conversion, PPE-UAT, GoLive, Stabilization). These specific tests and events (which may be defined within complexity prediction model 54) may be learned/informed/extended as new items are identified. Any new learnings may be immediately deployed by migration management process 10 and complexity prediction model 54 may be updated to define the same.

Examples of such specific tests and events may include but are not limited to:

| Deploy- | Deploy- | | | | |
|---|---|---|---|---|---|
| mentType | mentPhase | RequiredItem | ItemDescription | CheckType | CheckStatement |
| Needles 4 | Kickoff | Neos File Sync | Neos File Sync Agent is installed, | ops | NFSINSTALL |
| | | | configured and responding correctly | | |
| Needles 4 | Kickoff | SharePoint | Neos File Sync Agent is connected to | ops | SHAREPOINT |
| | | Configured | Firm SharePoint | | |
| Needles 4 | Kickoff | Sync Started | Neos File Sync Agent has begun | ops | NFSPROGRESS |
| | | | transferring files | | |
| Needles 4 | Kickoff | Neos Express | Neos Express Agent is installed, | ping | AGENT |
| | | Agent | configured and responding correctly | | |
| Needles 4 | Discovery | CEMLI Scoring | Assembly Software complexity scoring | ops | CEMLI |
| | | Provided | must be uploaded for firm | | |
| Needles 4 | Discovery | Deploy PPE | Provision Preproduction Neos | ops | PPEDEPLOYED |
| | | | Environment | | |
| Needles 4 | Discovery | DB Backup For | A database backup is required for | ops | PPEBACKUP |
| | | PPE | Preproduction Environment | | |
| Needles 4 | Discovery | Needles Version | Needles version must be greater than | sql | select database_version from systemdata |
| | | Check | 4.8.1 | | where database_version not like(′4.8%′) |
| | | | | | and database_version not like (′4.9%′) |
| Needles 4 | Discovery | Internet Speeds | Validate the internet connectivity is | ops | SPEEDTEST |
| | | | within supported ranges | | |
| Needles 4 | Implementation | Case Folder | Firm has validated all case folder | sign | NULL |
| | and Training | Mapping Accepted | mapping is functioning as expected | | |
| Needles 4 | Implementation | Merge Templates | All document templates must be an | sql | select list(IsNull(letter_title, ′Unnamed |
| | and Training | Are Office | office file type(.doc, .docx) | | Template′)) from wp_documents where |
| | | | | | (letter_path NOT LIKE(′% doc′) and |
| | | | | | letter_path NOT LIKE(′% docx′)) |
| Needles 4 | Implementation | O365 Account | An office 365 account with supported | sign | NULL |
| | and Training | | configuration and level must exist for | | |
| | | | the firm | | |
| Needles 4 | Implementation | Quickbooks | When using Quickbooks, the firm must | sign | NULL |
| | and Training | Integration | be trained and agree Neos functionality | | |
| | | Accepted | will support their workflow | | |
| Needles 4 | Implementation | Case Folders | All Active cases must have a single | sql | select substring(list(casenum),0,2048) from |
| | and Training | | default document location | | cases where len(doc_default_path) < 3 and |
| | | | | | close_date is null |
| Needles 4 | Implementation | Staff Calendar | All Staff with existing appointments | sql | select list(distinct(staff_id)) from calendar |
| | and Training | Sync | must sync calendars to office 365 | | where staff_id not in (Select distinct |
| | | | | | (staff_id) from outlook_calendar_ids) |
| Needles 4 | Implementation | Merge Templates | Firm has validated merge templates | sign | NULL |
| | and Training | Accepted | are functioning as expected | | |
| Needles 4 | Implementation | Custom Reports | Firm has validated custom reports | sign | NULL |
| | and Training | Accepted | are functioning as expected | | |
| Needles 4 | Production Go | Reports and | Final application of reports and | ops | REPORTS |
| | Live | Memos Applied | settlement memos against | | |
| | | | production tenant | | |
| Needles 4 | Production Go | Final Backup | A database backup is required for | ops | PRODBACKUP |
| | Live | | conversion and deployment into | | |
| | | | Production Environment | | |
| Needles 4 | Production Go | Production | Production Configurator has been | ops | PPECONFIG |
| | Live | Configurator | run to apply setup from | | |
| | | | Preproduction environment to | | |
| | | | Production environment | | |
| Needles 4 | Production Go | Deploy | Provision Production Neos | ops | PRODDEPLOY |
| | Live | Production | Environment | | |
| Needles 4 | Production Go | File and Folder | Firm has synced any file and folder | ops | FILESYNC |
| | Live | Deltas Syncd | changes since the time since last | | |
| | | | push to PPE | | |

The following discussion concerns the manner in which complexity prediction model 54 may be trained/updated.

### Model Training

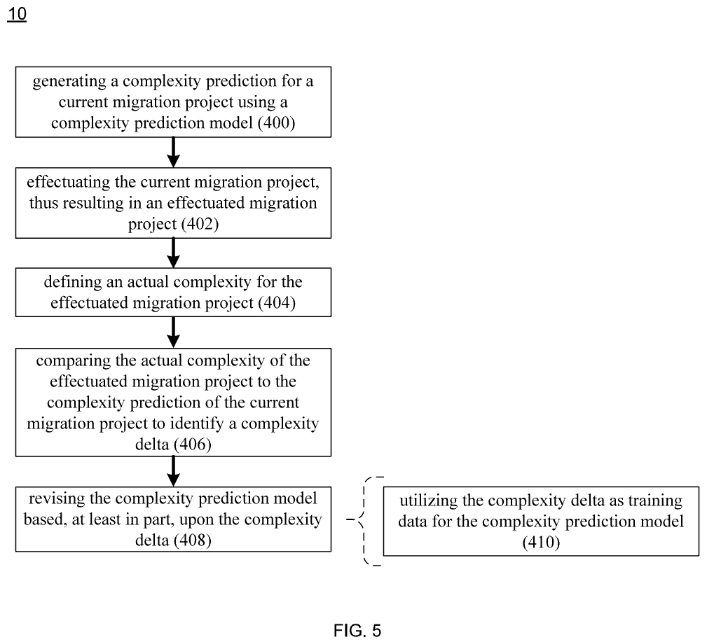

Referring also to FIG. 5 and as discussed above, migration management process 10 may generate 400 a complexity prediction for a current migration project (e.g., an on-premise to cloud IT migration project from on-premise computing platform 100 to cloud-based computing platform 102) using a complexity prediction model (e.g., complexity prediction model 54).

Generally speaking, this complexity prediction may concern one or more of: a complexity score assigned to each of the one or more migration portions of the current migration project (thus defining one or more complexity scores); and a project index assigned to the current migration project that defines the relative complexity of the current migration project based, at least in part, upon the one or more complexity scores.

For example and when generating 400 such a complexity prediction for the current migration project using complexity prediction model 54, migration management process 10 may assign 202 a complexity score to each of these five migration portions (thus defining complexity scores 106) and may assign 204 project index 108 that defines the relative complexity of the current migration project based, at least in part, upon these complexity scores (e.g., complexity scores 106).

Migration management process 10 may effectuate 402 the current migration project (e.g., an on-premise to cloud IT migration project from on-premise computing platform 100 to cloud-based computing platform 102), thus resulting in an effectuated migration project. Once the mitigation project is completed, migration management process 10 may define 404 an actual complexity for the effectuated migration project. Migration management process 10 may then compare 406 the actual complexity of the effectuated migration project to the complexity prediction of the current migration project to identify a complexity delta.

Accordingly, assume that the complexity prediction being scrutinized is the project index (e.g., project index 108). Further assume that the complexity prediction (that was predicted by migration management process 10 before the migration project began) was a project index of 1.60; while the actual complexity (that was realized by migration management process 10 after the migration project was completed) was a project index of 1.80. Accordingly, migration management process 10 may identify a complexity delta of +0.20 (or +12.50%)

Migration management process 10 may revise 408 the complexity prediction model (e.g., complexity prediction model 54) based, at least in part, upon the complexity delta (e.g., +0.20 or +12.50%). For example, migration management process 10 may revise 408 complexity prediction model 54 by e.g., revising one or more of the complexity calculation templates (as discussed above), component weights (as discussed above) and/or various other formulas/methodologies defined within complexity prediction model 54 to achieve the desired revision of complexity prediction model 54. As discussed above, the complexity prediction model (e.g., complexity prediction model 54) may be based, at least in part, upon prior-completed migration projects and may be generated by processing completion information associated with the prior-completed migration projects.

As is known in the art, Artificial intelligence (AI) utilizes historical data to make predictions about future outcomes through a process known as machine learning. This process involves several key steps. Initially, relevant historical data is collected from various sources, such as sensors, databases, or external datasets. Once collected, this data undergoes preprocessing to ensure cleanliness and suitability for analysis. Feature selection comes next, where the most pertinent attributes are chosen for the prediction task.

To train a predictive model (e.g., complexity prediction model 54), the historical data is divided into a training set and a testing set. The model selection process involves choosing an appropriate machine learning algorithm based on the nature of the data and the specific prediction problem. Training the model (e.g., complexity prediction model 54) is a crucial step where it learns patterns and relationships within the historical data, adjusting its internal parameters to minimize the difference between its predictions and actual outcomes.

Validation and tuning follow, as the model's performance is assessed using the testing set. Hyperparameters may be fine-tuned to optimize accuracy and generalization. Once the model (e.g., complexity prediction model 54) is ready, it's deployed in a production environment, where it processes new data (e.g., data concerning a new migration project) to make predictions about future outcomes. These predictions can take various forms, such as numeric values or class labels.

Continuous monitoring is essential to ensure the model's accuracy and relevance over time, as patterns in data may change. Feedback and retraining might be necessary to adapt the model to new information. Ultimately, AI leverages historical data, advanced algorithms, and ongoing learning to make predictions about future events, offering valuable insights and decision-making support across various domains.

Accordingly and when revising 408 the complexity prediction model (e.g., complexity prediction model 54) based, at least in part, upon the complexity delta (e.g., +0.20 or +12.50%), migration management process 10 may utilize 410 the complexity delta (e.g., +0.20 or +12.50%) as training data (e.g., training data 56) for the complexity prediction model (e.g., complexity prediction model 54).

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computer device, comprising:
assigning a complexity score to one or more migration portions of a migration pathway for a current migration project, thus defining one or more complexity scores; and
effectuating the current migration project via one or more agents.

2. The computer-implemented method of claim 1 wherein the one or more agents includes one or more of:
a project agent;
a file systems agent; and
an operational agent.

3. The computer-implemented method of claim 2 wherein the project agent is executed on a customer's network associated with the current migration project.

4. The computer-implemented method of claim 2 wherein the file systems agent is executed on a customer's network associated with the current migration project.

5. The computer-implemented method of claim 2 wherein the operational agent is executed on a service provider's network associated with the current migration project.

6. The computer-implemented method of claim 1 wherein the current migration project includes an on-premise to cloud IT migration project.

7. The computer-implemented method of claim 1 wherein each of the one or more migration portions concerns one or more of:
an application migration task;
a data migration task; and
a general migration task.

8. The computer-implemented method of claim 1 wherein each of the one or more complexity scores define the relatively complexity of each of the one or more migration portions.

9. The computer-implemented method of claim 1 further comprising:
assigning a project index to the current migration project that defines the relative complexity of the current migration project based, at least in part, upon one or more complexity scores.

10. The computer-implemented method of claim 9 wherein the project index has a normal value of one and the deviation of the project index above/below the normal value of one is indicative of the increased/decreased level of complexity of the current migration project with respect to a normal migration project.

11. The computer-implemented method of claim 1 further comprising:
defining staffing levels for the current migration project based, at least in part, upon the project index.

12. The computer-implemented method of claim 11 wherein defining staffing levels for the current migration project based, at least in part, upon the project index includes:
defining staffing levels for a plurality of phases of the current migration project based, at least in part, upon the project index.

13. A computer program product residing on a computer readable medium having a plurality of instructions stored thereon which, when executed by a processor, cause the processor to perform operations comprising:
assigning a complexity score to one or more migration portions of a migration pathway for a current migration project, thus defining one or more complexity scores; and
effectuating the current migration project via one or more agents.

14. The computer program product of claim 13 wherein the one or more agents includes one or more of:
a project agent;
a file systems agent; and
an operational agent.

15. The computer program product of claim 14 wherein the project agent is executed on a customer's network associated with the current migration project.

16. The computer program product of claim 14 wherein the file systems agent is executed on a customer's network associated with the current migration project.

17. The computer program product of claim 16 wherein the operational agent is executed on a service provider's network associated with the current migration project.

18. The computer program product of claim 13 wherein the current migration project includes an on-premise to cloud IT migration project.

19. The computer program product of claim 13 wherein each of the one or more migration portions concerns one or more of:
an application migration task;
a data migration task; and
a general migration task.

20. The computer program product of claim 13 wherein each of the one or more complexity scores define the relatively complexity of each of the one or more migration portions.

21. The computer program product of claim 13 further comprising:
assigning a project index to the current migration project that defines the relative complexity of the current migration project based, at least in part, upon one or more complexity scores.

22. The computer program product of claim 21 wherein the project index has a normal value of one and the deviation of the project index above/below the normal value of one is indicative of the increased/decreased level of complexity of the current migration project with respect to a normal migration project.

23. The computer program product of claim 13 further comprising:
defining staffing levels for the current migration project based, at least in part, upon the project index.

24. The computer program product of claim 23 wherein defining staffing levels for the current migration project based, at least in part, upon the project index includes:
defining staffing levels for a plurality of phases of the current migration project based, at least in part, upon the project index.

25. A computing system including a processor and memory configured to perform operations comprising:
assigning a complexity score to one or more migration portions of a migration pathway for a current migration project, thus defining one or more complexity scores; and
effectuating the current migration project via one or more agents.

26. The computing system of claim 25 wherein the one or more agents includes one or more of:
a project agent;
a file systems agent; and
an operational agent.

27. The computing system of claim 26 wherein the project agent is executed on a customer's network associated with the current migration project.

28. The computing system of claim 26 wherein the file systems agent is executed on a customer's network associated with the current migration project.

29. The computing system of claim 26 wherein the operational agent is executed on a service provider's network associated with the current migration project.

30. The computing system of claim 25 wherein the current migration project includes an on-premise to cloud IT migration project.

31. The computing system of claim 25 wherein each of the one or more migration portions concerns one or more of:
an application migration task;
a data migration task; and
a general migration task.

32. The computing system of claim 25 wherein each of the one or more complexity scores define the relatively complexity of each of the one or more migration portions.

33. The computing system of claim 25 further comprising:
assigning a project index to the current migration project that defines the relative complexity of the current migration project based, at least in part, upon one or more complexity scores.

34. The computing system of claim 33 wherein the project index has a normal value of one and the deviation of the project index above/below the normal value of one is indicative of the increased/decreased level of complexity of the current migration project with respect to a normal migration project.

35. The computing system of claim 25 further comprising:
defining staffing levels for the current migration project based, at least in part, upon the project index.

36. The computing system of claim 35 wherein defining staffing levels for the current migration project based, at least in part, upon the project index includes:
defining staffing levels for a plurality of phases of the current migration project based, at least in part, upon the project index.
